(19) United States
(12) Patent Application Publication
(10) Pub. No.: US 2023/0221185 A1
(43) Pub. Date: Jul. 13, 2023

(54) DISASTER PREVENTION APPARATUS

(71) Applicant: HOCHIKI Corporation, Tokyo (JP)

(72) Inventors: Keisuke Washizu, Tokyo (JP); Manabu Dohi, Tokyo (JP)

(21) Appl. No.: 18/118,788

(22) Filed: Mar. 8, 2023

Related U.S. Application Data
(63) Continuation-in-part of application No. PCT/JP2020/040838, filed on Oct. 30, 2020.

(51) Int. Cl. G01K 1/08; G01K 1/14

(52) U.S. Cl. CPC G01K 1/08; G01K 1/14; G01K 7/22

(57) ABSTRACT

A disaster prevention apparatus includes: an outer cover 11; a thermistor 14 that detects a physical quantity of a detection target; a protective portion 12 that accommodates the thermistor 14, that is provided on the outer cover 11, and that has an opening portion 122 through which the detection target flows in and out with respect to the thermistor 14; and a prevention portion 13 that prevents a contact object from coming into contact with the thermistor 14, and that is provided in the opening portion 122, wherein the prevention portion 13 is a projection, and the prevention portion 13 protrudes from the outer cover 11 side, the prevention portion 13 is provided at a position close to a center of an edge portion of the opening portion 122, and an outer surface of the prevention portion 13 is curved.

### CROSS REFERENCE TO RELATED APPLICATIONS

The present application claims the benefit of the PCT application No. PCT/JP2020/040838 filed on Oct. 30, 2020, the disclosure of which is incorporated by reference its entirety.

### INCORPORATION BY REFERENCE

All publications and patent applications mentioned in this specification are herein incorporated by reference in their entirety to the same extent as if each individual publication or patent application was specifically and individually indicated to be incorporated by reference.

### TECHNICAL FIELD

The present invention relates to a disaster prevention apparatus.

### BACKGROUND ART

In the related art, a detector that is installed on a ceiling, etc. to detect heat caused by fire has been known (for example, refer to Patent Literature 1). The detector detects heat by measuring a temperature with a thermistor accommodated in a protector.

### CITATION LIST

### Patent Literature

Patent Literature 1: Laid-Open Patent Publication in Japan No. 2012-198757

### SUMMARY OF INVENTION

### Technical Problem

By the way, for example, in the detector that detects heat, including the detector of Patent Literature 1, generally, there is a demand for improving an inflow characteristic of a hot air current to the thermistor accommodated in the protector.

However, widening an opening portion of the protector is required to meet the demand, but when the opening portion is widened too much, there is a possibility that a user's finger enters the detector through the opening portion during installation, and damages the thermistor.

It is an object of the present invention to solve the problems of the above mentioned prior arts.

### Solution to Problem

One aspect of the present invention provides a disaster prevention apparatus comprises: an outer cover; a detection element that detects a physical quantity of a detection target; a detection element protector that accommodates the detection element, that is provided on the outer cover, and that has an opening portion through which the detection target flows in and out with respect to the detection element; and a preventor that prevents a contact object from coming into contact with the detection element, and that is provided in the opening portion, wherein the preventor is a projection.

### BRIEF DESCRIPTION OF DRAWINGS

FIG. 1 is a perspective view of a detector according to an embodiment.

FIG. 2 is a plan view of the detector.

FIG. 3 is a side view of the detector.

FIG. 4 is a cross-sectional view taken along line A-A of FIG. 2.

FIG. 5 is an enlarged view of a part of FIG. 3.

FIG. 6 is a view showing an optical path in FIG. 4 as an example.

### DESCRIPTION OF EMBODIMENTS

Hereinafter, an embodiment of a disaster prevention apparatus according to the invention will be described in detail with reference to the drawings. Incidentally, the invention is not limited by the embodiment.

### Basic Concept of Embodiment

First, the basic concept of the embodiment will be described. The embodiment generally relate to the disaster prevention apparatus.

The “disaster prevention apparatus” is an apparatus used for prevention of a disaster, for example, is a concept including an apparatus that detects an abnormality of a monitoring region, etc., and as one example, is a concept including a heat detector, a fire detector, a gas detector, a smoke detector, etc. In addition, the “disaster prevention apparatus” includes, for example, an outer cover, a detection element, a detection element protector, and a preventor.

The “monitoring region” is a region to be monitored by the disaster prevention apparatus, specifically, is a certain extent of space and, for example, is a concept including a room (for example, a first-floor room A, a first-floor room B, etc.), a corridor, and a stair of a building, etc. In addition, the “abnormality of the monitoring region” indicates that the state of the monitoring region is different from a normal state and, specifically, is a concept including a fire outbreak, a gas leakage, etc.

The “outer cover” covers, for example, at least some of components of the disaster prevention apparatus.

The “detection element” is, for example, a component that detects a physical quantity of the detection target and as one example, is a concept including a temperature sensor such as a thermistor, a smoke sensor formed of a light emitting diode, a photodiode, etc., a gas sensor, etc. The “physical quantity of the detection target” is, for example, a quantity that can be generated or changed due to an abnormality of the monitoring region, and as one example, is a concept including temperature caused by heat, smoke concentration, the concentration of gas such as carbon monoxide gas, etc. Here, the “detection target” is, for example, a concept including a hot air current when the physical quantity to be detected is heat (temperature), an air current containing smoke particles when the physical quantity to be detected is smoke concentration, an air current containing carbon monoxide gas when the physical quantity to be detected is gas concentration, for example, carbon monoxide concentration, etc.

The “detection element protector” accommodates the detection element, specifically, is provided on the outer cover, and is a concept including a detection element protector having an opening portion configured such that the detection target flows in and out toward the detection element through the opening portion, etc. Specifically, the “detection element protector” is a concept including, for example, a thermistor guard that protects a thermistor while allowing a hot air current to flow in from the outside toward the thermistor as the detection element provided in a heat detector, and to flow out from a thermistor side to the outside, for example, a smoke sensor guard portion or a smoke sensor accommodation cover portion that protects a smoke detection unit while allowing an air current containing smoke particles to flow in from the outside to the smoke detection unit as a smoke sensor provided in a smoke detector, through a smoke inlet and outlet port that is an opening, and to flow out from the smoke detection unit to the outside, etc.

The “preventor” is a preventor that prevents the contact object from coming into contact with the detection element, and that is provided in the opening portion of the detection element protector, and specifically, is a projection. In addition, for example, the “preventor” is a concept including a preventor protruding from an outer cover side, etc., is a concept including a preventor provided at a position close to a center of an edge portion of the opening portion, etc., is a concept including a configuration in which an outer surface of the preventor is curved, etc., and a concept including a configuration in which at least one preventor is provided for a plurality of the opening portions, etc.

Incidentally, the “contact object” is an object that is prevented from coming into contact with the detection element by the preventor, and is a concept including, for example, a user's finger, etc.

In addition, in the following embodiment, the case where the “disaster prevention apparatus” is a heat detector will be described.

### Specific Contents of Embodiment

Next, specific contents of the embodiment will be described.

### Configuration—Detector

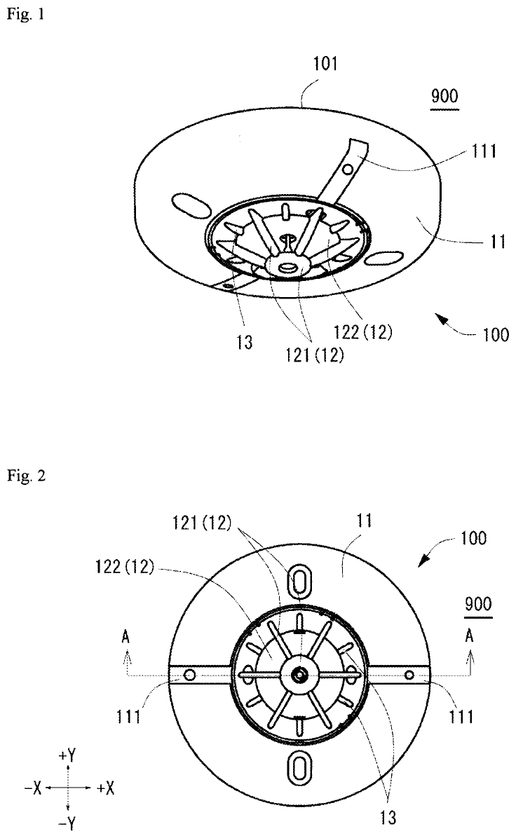

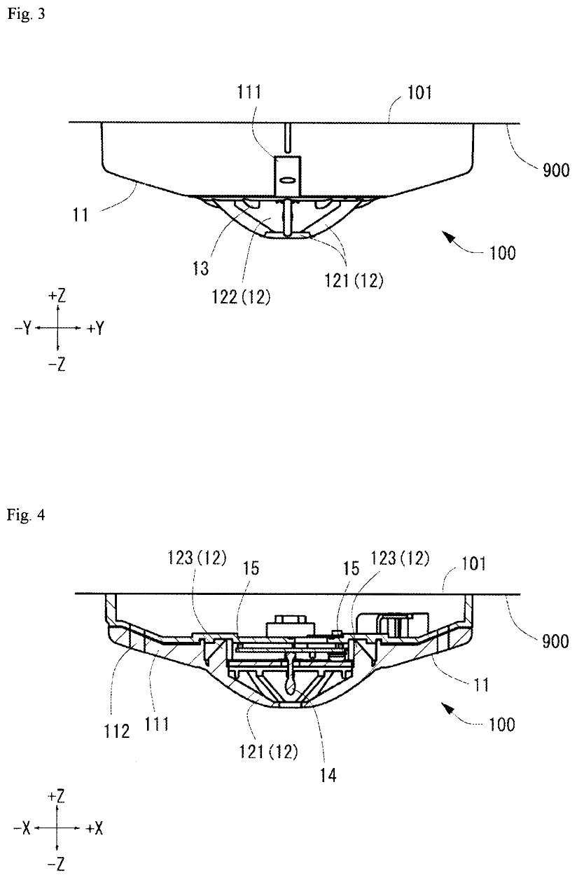

First, a configuration of a detector of the present embodiment will be described. FIG. 1 is a perspective view of the detector according to the embodiment of the invention, FIG. 2 is a plan view of the detector, FIG. 3 is a side view of the detector, and FIG. 4 is a cross-sectional view taken along line A-A of FIG. 2. Incidentally, in each drawing, a Z axis, and an X axis and a Y axis orthogonal to the Z axis will be described as indicating a vertical direction and a horizontal direction, respectively. A detector 1 of each drawing is a disaster prevention apparatus, specifically, is a heat detector that detects heat, is attached to, for example, an attachment object 900 such as a ceiling, through an attachment portion 101 (detailed structure is not shown) of the detector 100 of FIG. 3, and as one example, includes an outer cover 11, a protective portion 12, and prevention portions 13 of FIG. 1, and a thermistor 14 and a light emitter 15 of FIG. 4.

### Configuration—Detector—Outer Cover)

The outer cover 11 of FIG. 1 covers at least some of components of the detector 100. A specific type or configuration of the outer cover 11 is any type or any configuration, however, for example, as shown in FIG. 3, the outer cover 11 includes a cylindrical portion of which the diameter is the same even when extending away from the attachment portion 101, and a tapered portion that is reduced in diameter as extending away from the attachment portion 101, has a light-shielding property except for a specified portion, and includes light guide portions 111 of FIG. 2. Incidentally, the “light-shielding property” is the ability to block light and, for example, is a concept indicating the ability of the outer cover 11 to prevent light from passing from the inside to the outside.

The light guide portions 111 are light guides that guide light. A specific type or configuration of the light guide portions 111 is any type or any configuration, however, for example, the light guide portions 111 is formed in a part of the outer cover 11, are made of any material so as to function as light guides that guide and emit light, are formed separately from portions of the outer cover 11 having a light-shielding property, and allow light to pass through the outer cover 11 from the inside to the outside. In addition, the light guide portions 111 extend, for example, from a front portion side (−Z direction) of the outer cover 11 to a side portion side (+X direction or −X direction) of the outer cover 11, two light guide portions 111 are provided, and as shown in FIG. 2, the light guide portions 111 have a linear shape.

### Configuration—Detector—Protective Portion

The protective portion 12 of FIG. 1 is the aforementioned detection element protection. A specific type or configuration of the protective portion 12 is any type or any configuration, however, for example, the protective portion 12 is formed in a part of the outer cover 11, is made of any material so as to function as a light guide that guides and emits light, is formed separately from the portions of the outer cover 11 having a light-shielding property, and allows light to pass through the outer cover 11 from the inside to the outside. In addition, the protective portion 12 is, for example, a so-called thermistor guard that protects the thermistor 14 of FIG. 4, has a hollow portion for accommodating the thermistor 14, protrudes from the outer cover 11 toward a side opposite the attachment portion 101 (−Z direction), is provided at a center of the outer cover 11 in a direction in which the outer cover 11 is widened (direction parallel to an X-Y plane), and is integrally formed with the light guide portions 111. In addition, the protective portion 12 includes, for example, a frame portion 121 and opening portions 122 of FIG. 1, and a spectroscopic portion 123 of FIG. 4.

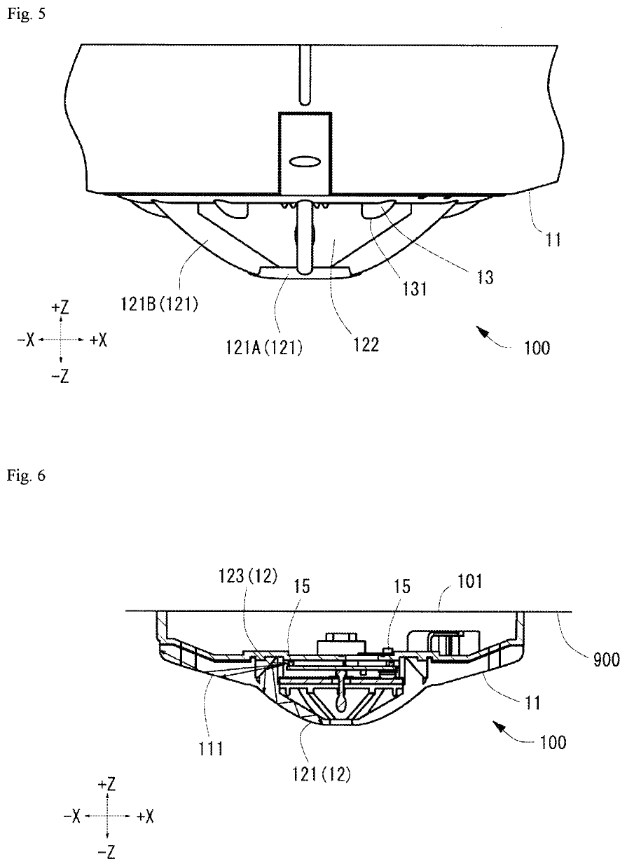

FIG. 5 is an enlarged view of a part of FIG. 3. The frame portion 121 shown in FIG. 5 is, for example, a portion forming an outer shape of at least a part of the protective portion 12, and is a portion including one circular member 121A forming a tip portion (−Z direction) of the detector 100, and six support members 121B between the circular member 121A and the outer cover 11, the support members 121B supporting the circular member 121A.

The opening portions 122 are, for example, portions through which a hot air current flows in and out with respect to the thermistor 14 of FIG. 4 provided in the hollow portion of the protective portion 12, and six opening portions 122 are provided in such a manner to be partitioned off by the aforementioned six support members 121B of FIG. 5 of the frame portion 121.

The spectroscopic portion 123 of FIG. 4 is, for example, a portion that refracts, disperses, or reflects light output from the light emitter 15, and is a portion facing the light emitter 15.

### Configuration—Detector—Prevention Portion

The prevention portions 13 of FIG. 1 are the preventors that prevent a user's finger, which is the contact object, from coming into contact with the thermistor 14 accommodated in the protective portion 12. A specific type or configuration of the prevention portions 13 is any type or any configuration, however, for example, are projections provided in the opening portions 122, as shown in FIG. 5, protrude from an outer cover 11 side, are provided at positions close to centers of edge portions of the opening portions 122, and as shown in FIG. 2, six prevention portions 13, one for each of the opening portions 122, are provided. In addition, outer surfaces 131 of the prevention portions 13 of FIG. 5 are curved, and specifically, are curved to approach a circular member 121A side (−Z direction) (namely, the distance from the outer cover 11 increases) in a height direction (Z-axis direction) from an outer side toward an inner side of the detector 1 in the direction in which the outer cover 11 is widened (direction parallel to the X-Y plane).

Incidentally, the sizes of the prevention portions 13 and the opening portions 122 are any sizes, but are determined, for example, so as to prevent a user's finger from entering the hollow portion through the opening portion 122 and coming into contact with the thermistor 14, while considering an inflow and an outflow of a hot air current with respect to the thermistor 14 side in the hollow portion of the protective portion 12. Incidentally, in this case, regarding the size of the user's finger, a size determined in advance may be assumed, or a size of a predetermined test finger may be assumed.

### Configuration—Detector—Thermistor

The thermistor 14 of FIG. 4 is the aforementioned detection element. A specific type or configuration of the thermistor 14 is any type or any configuration, however, the thermistor 14 detects, for example, a temperature caused by heat or a hot air current, protrudes in a direction orthogonal to the direction in which the outer cover 11 is widened (Z-axis direction), and is accommodated in the protective portion 12.

### Configuration—Detector—Light Emitter

The light emitter 15 of FIG. 4 is the aforementioned light emitter. A specific type or configuration of the light emitter 15 is any type or any configuration, however, for example, the light emitter 15 causes the light guide portions 111 and the protective portion 12 to emit light, outputs light toward the spectroscopic portion 123, and can be formed of a light emitting diode, etc.

### Prevention of Contact

Next, the prevention of contact of a user's finger with the thermistor 14 of the detector 100 configured in such a manner will be described. It is assumed that a user performs work while holding the detector 100 with the hand at any timing such as when the detector 100 is installed, however, in this case, when a user's finger enters the hollow portion of the protective portion 12 through the opening portion 122 of FIG. 5, the user's finger comes into contact with the prevention portion 13 provided in the opening portion 122, so that the user's finger is stopped by the prevention portion 13 and the user's finger is prevented from coming into contact with the thermistor 14. Therefore, damage to the thermistor 14 caused by contact can be prevented. In addition, electrostatic breakdown caused by the approach of the user's finger to the thermistor can be prevented.

### Emission of Light

Next, the emission of light by the detector 100 configured in such a manner will be described. Incidentally, the detector 100 emits light at any timing, and for example, any timing such as when a state of the detector 100 is notified or when the detector 100 determines a fire outbreak based on a temperature of heat detected by the thermistor 14 is assumed. Incidentally, since the same process as in the related art is applicable to a process in which the detector 100 determines a fire outbreak, the description thereof will not be repeated. FIG. 6 is a view showing an optical path in FIG. 4 as an example.

A control unit (not shown) of the detector 100 of FIG. 6 causes the light emitter 15 to output light. In this case, the light from the light emitter 15 is refracted, dispersed, or reflected by the spectroscopic portion 123, and as shown in FIG. 6, is guided to the entireties of the light guide portions 111 and the protective portion 12. Incidentally, in FIG. 5, for convenience of description, only an optical path of light from the light emitter 15 on the left side of the drawing sheet is shown, but in reality, light is also output from the light emitter 15 on the right side of the drawing sheet, and is guided to the entireties of the light guide portions 111 and the protective portion 12. Then, the entireties of the light guide portions 111 and the protective portion 12 of FIG. 1 emit the light. Since the light is emitted in such a manner, the light emitted from the detector 100 can be viewed from any position in a room in which the detector 100 is installed.

### Effects of Embodiment

In such a manner, according to the present embodiment, since the prevention portions 13 provided in the opening portions 122 are provided and the prevention portions 13 are projections, for example, even when the size of the opening portions 122 is set to be relatively large, the projection comes into contact with a finger trying to enter the thermistor 14 side through the opening portion 122, so that it is possible to prevent the user's finger that is a contact object from coming into contact with the thermistor 14 while improving an inflow characteristic of a hot air current that is a detection target, with respect to the thermistor 14. In addition, electrostatic breakdown caused by the approach of the user's finger to the thermistor 14 can be prevented.

In addition, since the prevention portions 13 protrude from the outer cover 11 side, for example, strength of peripheries of the prevention portions 13 can be improved, so that the peripheries of the prevention portions 13 can be prevented from being damaged when a contact object comes into contact with the prevention portions 13.

In addition, since the prevention portions 13 are provided at positions close to the centers of the edge portions of the opening portions 122, for example, a contact object can be reliably prevented from entering the thermistor 14 side, so that the contact object can be reliably prevented from coming into contact with the thermistor 14. In addition, for example, electrostatic breakdown caused by the approach of a user's finger to the thermistor 14 can be prevented.

In addition, since the outer surfaces 131 of the prevention portions 13 are curved, for example, when a contact object comes into contact with the prevention portion 13, a user with a finger that is the contact object can be prevented from feeling pain. In addition, for example, since a detection target can flow in along the outer surfaces of the prevention portions 13, an inflow characteristic of the detection target can be improved. In addition, for example, since a unified impression can be provided to the entirety of the detector 100, the design of the detector 100 can be improved.

In addition, since at least one prevention portion 13 is provided for a plurality of the opening portions 122, for example, a contact object can be reliably prevented from entering the thermistor 14 side, so that the contact object can be reliably prevented from coming into contact with the thermistor 14. In addition, for example, electrostatic breakdown caused by the approach of a user's finger to the thermistor 14 can be prevented.

### Modification Examples of Embodiment

The embodiment according to the invention have been described above, but the specific configurations, unit, and portions of the invention can be modified and improved in any manner within the scope of the technical concept of each invention in the appended claims. Hereinafter, such modification examples will be described.

### Regarding Technical Problem and Effects of Invention

First, the technical problems and the effects of the invention are not limited to the above-described contents, and may differ depending on details of an implementation environment or configuration of the invention, and only some of the above-described problems may be solved, or only some of the above-described effects may be obtained.

### Regarding Segregation and Integration

In addition, the above-described configurations are functionally conceptual, and do not necessarily need to be physically configured as shown in the drawings. Namely, the specific modes of the segregation and integration of the portions are not limited to those shown in the drawings, and all or some thereof can be configured to be functionally or physically segregated or integrated in any unit.

### Regarding Prevention Portion

In addition, a configuration of the prevention portions 13 of FIG. 2 may be changed in any manner. For example, two prevention portions 13 may be provided for each of the opening portions 122, or the prevention portion 13 may be provided for only some opening portions 122 of the six opening portions 122. In addition, for example, the position where the prevention portion is provided in the opening portion 122 may be changed in any manner, and as one example, the prevention portion 13 may be provided on the circular member 121A or on the support member 121B in FIG. 5.

### Regarding Features

In addition, the configurations of the embodiment and the features of the modification examples may be combined in any manner.

One embodiment of the present invention provides a disaster prevention apparatus comprises: an outer cover; a detection element that detects a physical quantity of a detection target; a detection element protector that accommodates the detection element, that is provided on the outer cover, and that has an opening portion through which the detection target flows in and out with respect to the detection element; and a preventor that prevents a contact object from coming into contact with the detection element, and that is provided in the opening portion, wherein the preventor is a projection.

According to this embodiment, since the preventor is provided in the opening portions and the preventor is a projection, for example, even when the size of the opening portions is set to be relatively large, the projection comes into contact with a finger trying to enter the detection element side through the opening portion, so that it is possible to prevent contact of the contact object with the detection element, while improving an inflow characteristic of a detection target with respect to the detection element. In addition, electrostatic breakdown caused by the approach of the contact object to internal components such as the detection element can be prevented.

Another embodiment of the present invention provides the disaster prevention apparatus according to the above embodiment, wherein the preventor protrudes from the outer cover side.

According to this embodiment, since the preventor protrudes from the outer cover side, for example, strength of peripheries of the preventor can be improved, so that the peripheries of the preventor can be prevented from being damaged when the contact object comes into contact with the preventor.

Another embodiment of the present invention provides the disaster prevention apparatus according to the above embodiment, wherein the preventor is provided at a position close to a center of an edge portion of the opening portion.

According to this embodiment, since the preventor is provided at positions close to the centers of the edge portions of the opening portions, for example, a contact object can be reliably prevented from entering the detection element side, so that the contact object can be reliably prevented from coming into contact with the detection element. In addition, for example, electrostatic breakdown caused by the approach of the contact object to internal components such as the detection element can be prevented.

Another embodiment of the present invention provides the disaster prevention apparatus according to the above embodiment, wherein an outer surface of the preventor is curved.

According to this embodiment, since the outer surfaces of the preventor are curved, for example, when a contact object comes into contact with the preventor, a user with a finger that is the contact object can be prevented from feeling pain. In addition, for example, since a detection target can flow in along the outer surfaces of the preventor, an inflow characteristic of the detection target can be improved. In addition, for example, since a unified impression can be provided to the entirety of the disaster prevention apparatus the design of the disaster prevention apparatus can be improved.

Another embodiment of the present invention provides the disaster prevention apparatus according to the above embodiment, wherein the plurality of the opening portions are provided, and at least the one preventor is provided for the plurality of opening portions.

According to this embodiment, since at least one preventor is provided for a plurality of the opening portions, for example, a contact object can be reliably prevented from entering the detection element side, so that the contact object can be reliably prevented from coming into contact with the detection element. In addition, for example, electrostatic breakdown caused by the approach of the contact object to internal components such as the detection element can be prevented.

Another embodiment of the present invention provides the disaster prevention apparatus according to the above embodiment, wherein the disaster prevention apparatus is at least a heat detector.

According to this embodiment, since the disaster prevention apparatus is at least a heat detector, for example, it is possible to prevent contact of the contact object with the detection element, while improving an inflow characteristic of a detection target with respect to the detection element, and it is possible to provide a heat detector wherein electrostatic breakdown caused by the approach of the contact object to internal components such as the detection element can be prevented.

### REFERENCE SIGNS LIST

11: outer cover
12: protective portion
13: prevention portion
14: thermistor
15: light emitter
100: detector
101: attachment portion
111: light guide portion
121: frame portion
121A: circular member
121B: support member
122: opening portion
123: spectroscopic portion
131: outer surface
900: attachment object

1. A disaster prevention apparatus comprising:
an outer cover;
a detection element that detects a physical quantity of a detection target;
a detection element protector that accommodates the detection element, that is provided on the outer cover, and that has an opening portion through which the detection target flows in and out with respect to the detection element; and
a preventor that prevents a contact object from coming into contact with the detection element, and that is provided in the opening portion,
wherein the preventor is a projection.

2. The disaster prevention apparatus according to claim 1,
wherein the preventor protrudes from the outer cover side.

3. The disaster prevention apparatus according to claim 1,
wherein the preventor is provided at a position close to a center of an edge portion of the opening portion.

4. The disaster prevention apparatus according to claim 1,
wherein an outer surface of the preventor is curved.

5. The disaster prevention apparatus according to claim 1,
wherein the plurality of the opening portions are provided, and
at least the one preventor is provided for the plurality of opening portions.

6. The disaster prevention apparatus according to claim 1,
wherein the disaster prevention apparatus is at least a heat detector.
